(19) United States
(12) Patent Application Publication
(10) Pub. No.: US 2025/0069322 A1
(43) Pub. Date: Feb. 27, 2025

(54) ELECTRONIC DEVICE FOR COMPOSITING IMAGES ON BASIS OF DEPTH MAP AND METHOD THEREFOR

(71) Applicant: NCSOFT Corporation, Seoul (KR)

(72) Inventors: Gunhee LEE, Seoul (KR); Jonghwa YIM, Seoul (KR); Chanran KIM, Seoul (KR); Minjae KIM, Seoul (KR)

(73) Assignee: NCSOFT Corporation, Seoul (KR)

(21) Appl. No.: 18/941,838

(22) Filed: Nov. 8, 2024

Related U.S. Application Data
(63) Continuation of application No. PCT/KR2022/006846, filed on May 12, 2022.

(51) Int. Cl. G06T 15/20; G06T 7/50; G06T 7/90

(52) U.S. Cl. CPC G06T 15/205; G06T 7/50; G06T 7/90; G06T 2200/24; G06T 2207/20084

(57) ABSTRACT

An electronic device according to one embodiment may include memory storing instructions and at least one processor operably coupled to the memory. The at least one processor may be configured to, when the instructions are executed, identify a first image comprising one or more areas distinguished by one or more colors; obtain at least one depth map based on the first image, wherein the at least one depth map comprises the one or more areas in the first image; and obtain, based on the first image and the at least one depth map, a virtual image including one or more subjects indicated by colors of the one or more areas.

### CROSS-REFERENCES TO RELATED APPLICATIONS

This application is a continuation of International Application No. PCT/KR2022/006846, filed on May 12, 2022, at the Korean Intellectual Property Office, the disclosure of which is incorporated herein by reference in its entirety.

### FIELD

### 1. Technical Field

The following descriptions relate to an electronic device for compositing images on a basis of a depth map and a method therefor.

### 2. Background

An electronic device and a method for synthesizing (or compositing) an image are being developed. An electronic device may receive information (e.g., text, and/or photograph) required for image composition from a user. Using the received information, the electronic device may synthesize a virtual image.

### SUMMARY

An electronic device according to an embodiment may comprise memory for storing instructions and at least one processor operably coupled to the memory. The at least one processor may be configured to, when the instructions are executed, identify a first image comprising one or more areas distinguished by one or more colors; obtain at least one depth map based on the first image, wherein the at least one depth map comprises the one or more areas in the first image; and obtain, based on the first image and the at least one depth map, a virtual image including one or more subjects indicated by colors of the one or more areas.

A method of generating a virtual image, the method being executed by at least one processor of an electronic device according to an embodiment may include identifying a semantic map indicating shapes and locations of one or more subjects; obtaining a plurality of candidate depth maps based on the semantic map, wherein the plurality of candidate depth maps comprise depth values of a plurality of pixels included in the semantic map; identifying a depth map corresponding to the semantic map based on the plurality of candidate depth maps; and obtaining, one or more images in which the one or more subjects are positioned based on the identified depth map, and the semantic map.

A non-transitory computer readable medium storing instructions, wherein the instructions cause at least one processor to: identifying a first image comprising one or more areas distinguished by one or more colors; obtaining at least one depth map based on the first image, wherein the at least one depth map comprises the one or more areas included in the first image; and obtaining, based on the first image and the at least one depth map, a virtual image including one or more subjects indicated by colors of the one or more areas.

### BRIEF DESCRIPTION OF THE DRAWINGS

FIG. 1 is an exemplary diagram illustrating an operation in which an electronic device generates an image, according to an embodiment.

FIG. 2 is a block diagram of an electronic device, according to an embodiment.

FIG. 3 is an exemplary diagram illustrating a depth map that an electronic device generates from an image, according to an embodiment.

FIG. 4 is an exemplary diagram illustrating distribution of a depth value in a depth map generated by an electronic device, according to an embodiment.

FIG. 5 is an exemplary diagram illustrating an operation in which an electronic device generates one or more images based on an image received from a user and a depth map generated from the image, according to an embodiment.

FIG. 6 is a diagram illustrating a plurality of neural networks for generating an image, according to an embodiment.

FIG. 7 is a block diagram illustrating a structure of a model according to an embodiment.

FIG. 8 is a diagram illustrating a neural network, according to an embodiment.

FIG. 9 is a diagram illustrating an operation of generating a data set for training a model for generating an image, according to an embodiment.

FIG. 10 is a diagram illustrating an operation of an electronic device, according to an embodiment.

FIG. 11 is a diagram illustrating an operation of an electronic device, according to an embodiment.

FIG. 12 is a diagram illustrating an operation of training a neural network of an electronic device, according to an embodiment.

### DETAILED DESCRIPTION

Hereinafter, various embodiments of this document will be described with reference to attached drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

Increasing quality of an image that an electronic device synthesizes to a degree similar to a photograph is required as related techniques do not synthesize images to a degree similar to a photograph.

Specifically, methods are needed for generating another image similar to a photograph from an image including areas specified by a user, including at least one subject positioned along the areas.

According to an embodiment, an electronic device can synthesize an image having a quality similar to a photograph.

According to an embodiment, the electronic device can generate another image similar to a photograph, including at least one subject positioned along areas, from an image including the areas specified by a user.

The effects that can be obtained from the present disclosure are not limited to those described above, and any other effects not mentioned herein will be clearly understood by those having ordinary knowledge in the art to which the present disclosure belongs, from the following description.

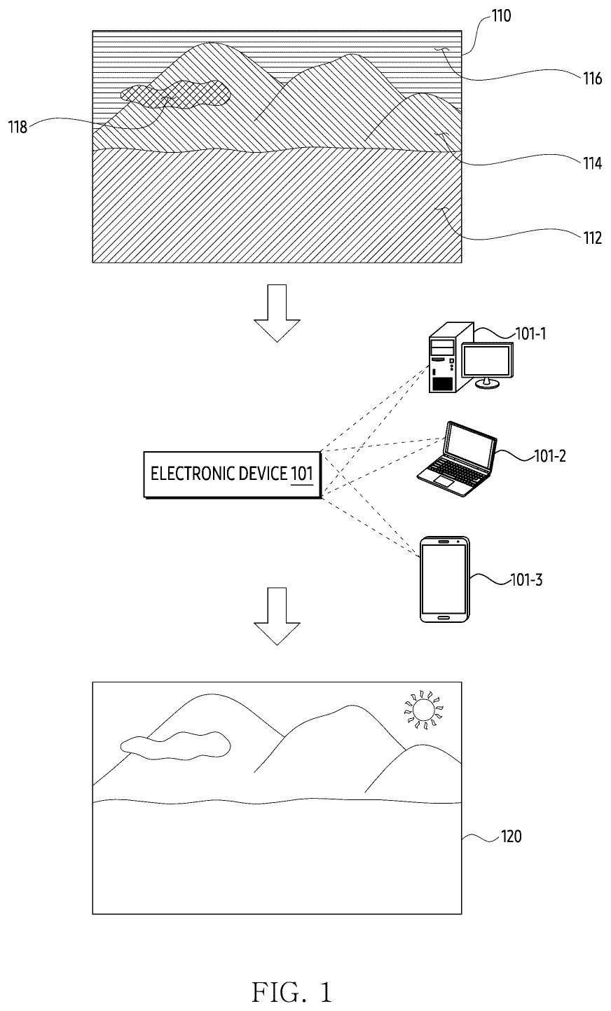

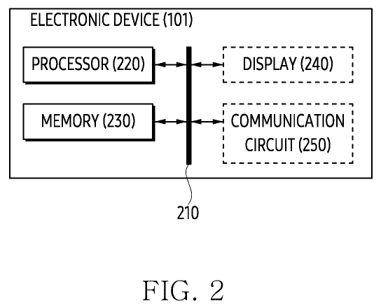

FIG. 1 is an exemplary diagram for illustrating an operation in which an electronic device 101 generates an image, according to an embodiment. According to an embodiment, an electronic device 101 may include a personal computer (PC) such as a desktop 101-1 and/or a laptop 101-2. According to an embodiment, the electronic device 101 may include a smartphone, a smart-pad, and/or a tablet personal computer (PC), like a terminal 101-3. According to an embodiment, a form factor of the electronic device 101 is not limited to the examples of FIG. 1, and may include, for example, smart accessories such as a smartwatch and a head-mounted device (HMD). According to an embodiment, one or more hardware included in the electronic device 101 will be described with reference to FIG. 2.

According to an embodiment, the electronic device 101 may generate a second image 120 based on a first image 110. The electronic device 101 may obtain the first image 110 from a user. For example, the electronic device 101 may display a user interface (UI) for receiving the first image 110 to the user. Through the UI, the electronic device 101 may obtain the first image 110. The first image 110 received by the electronic device 101 may be referred to as an input image, and may include an image, a segmentation map, and/or a semantic map. The second image 120 generated by the electronic device 101 may be referred to as an output image, a virtual image, and/or a virtual photograph.

FIG. 1 illustrates an example of the first image 110 received from the user by the electronic device 101 according to an embodiment. The first image 110 may include one or more areas (e.g., areas 112, 114, 116, and 118) distinguished by one or more colors. For example, the areas 112, 114, 116, and 118 may be filled with distinct colors. For example, the first image 110 may include a semantic map indicating one or more subjects in another image (e.g., the second image 120) to be synthesized from the first image 110, based on one or more areas (e.g., the areas 112, 114, 116, and 118) filled with colors.

In an embodiment, semantic map may by the first image 110 and may include semantic information of an image corresponding to the semantic map. The semantic information may include information representing a type, a category, a position, and/or a size of a subject captured within the image. For example, the semantic map may include a plurality of pixels corresponding to each pixel within the image and representing the semantic information based on a position and/or color. In the semantic map, a group of pixels having a specific color may represent a position and/or a size in which a subject of a type corresponding to the specific color is captured within the image. For example, the areas 112, 114, 116, and 118 may be an example of the group of pixels having the specific color.

Referring to FIG. 1, the first image 110, which is an example of the semantic map, may represent a size and/or a category of one or more subjects to be included within another image to be synthesized from the first image 110, based on the size and/or the color of the areas 112, 114, 116, and 118. For example, the area 112 may be filled with a first color (e.g., green) representing lowland. For example, the area 114 may be filled with a second color (e.g., brown) representing a mountain. For example, the area 116 may be filled with a third color (e.g., blue) representing the sky. For example, the area 118 may be filled with a fourth color (e.g., white) representing a cloud. The first color to the fourth color may be indicated by a one-dimensional vector based on a color space such as RGB, CMYK, and/or YCbCr. Since the areas 112, 114, 116, and 118 are distinguished into distinct colors (e.g., the first color to the fourth color), the first image 110 including the areas 112, 114, 116, and 118 may not include any other color except the first color to the fourth color.

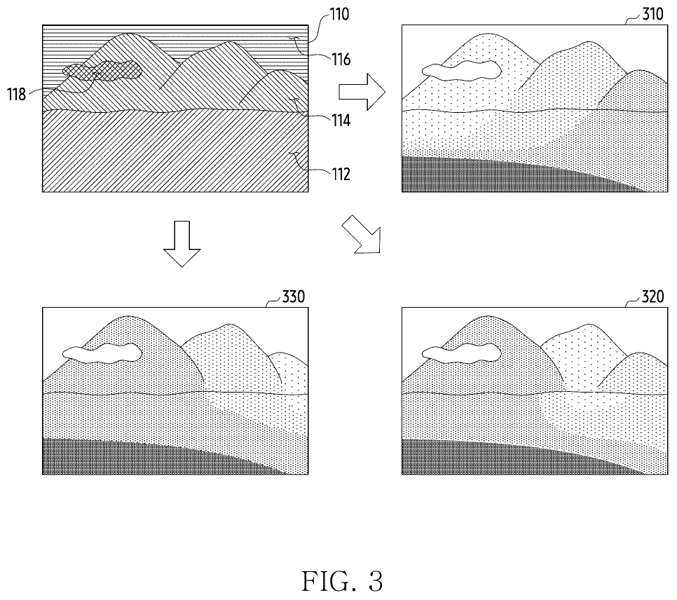

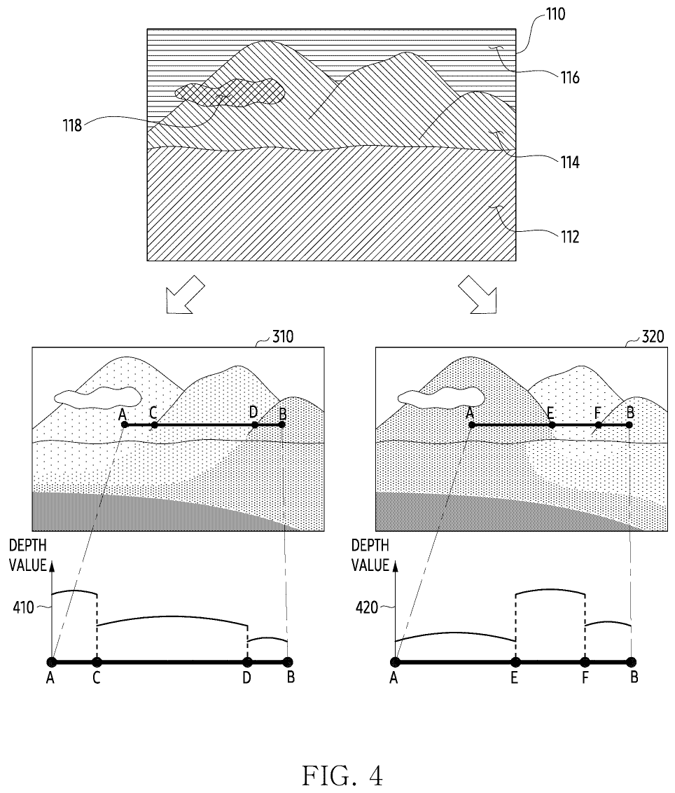

According to an embodiment, the electronic device 101 may obtain information for generating the second image 120 from the first image 110. The information may be information for providing perspective to one or more subjects to be positioned based on the areas 112, 114, 116, and 118 of the first image 110. The information may be referred to as a depth map. The depth map may include a plurality of pixels corresponding to each of the pixels in the semantic map (e.g., the first image 110) and having numeric values representing perspective of each of the pixels in the semantic map. The numeric values may be referred to as depth values. According to an embodiment, the depth map that the electronic device 101 obtains from the first image 110 will be described with reference to FIGS. 3 to 4.

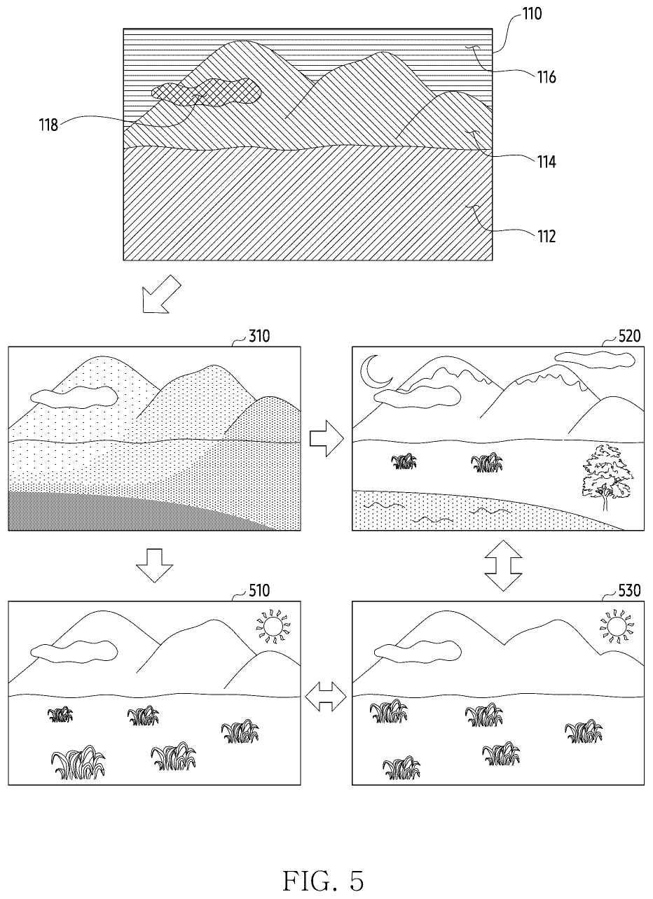

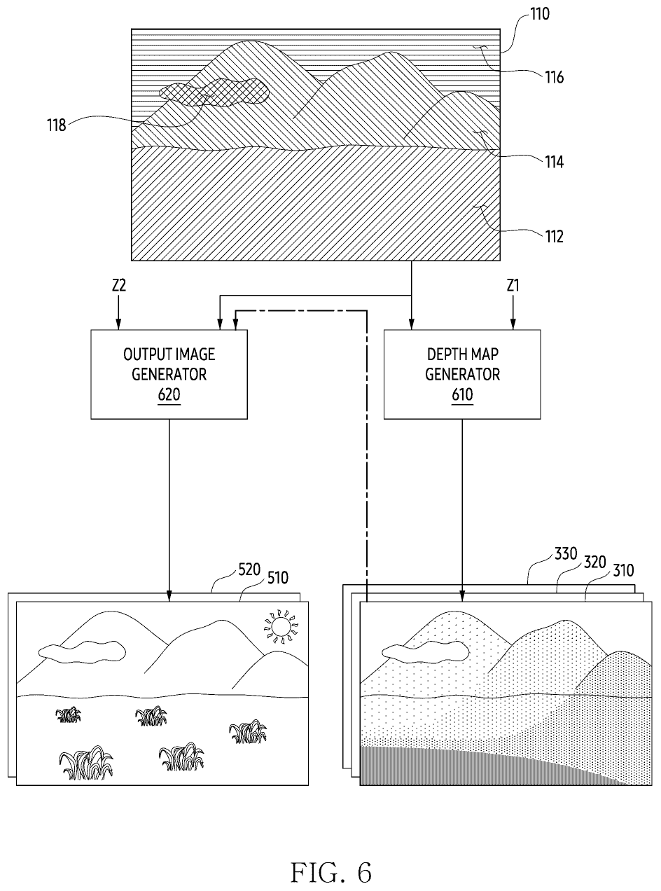

According to an embodiment, the second image 120 that the electronic device 101 obtains based on the first image 110 may include one or more subjects positioned based on the areas 112, 114, 116, and 118 of the first image 110. Referring to FIG. 1, the electronic device 101 may display the lowland within a portion of the second image 120 corresponding to the area 112 of the first image 110, one or more mountains within a portion of the second image 120 corresponding to the area 114 of the first image 110, the sky within a portion of the second image 120 corresponding to the area 116 of the first image 110, and the cloud within a portion of the second image 120 corresponding to the area 118 of the first image 110. According to an embodiment, the electronic device 101 may adjust perspective of the one or more subjects included within the second image 120 based on the depth map obtained from the first image 110. For example, the electronic device 101 may generate the second image 120, such that one or more mountains positioned within the portion of the second image 120 corresponding to the area 114 of the first image 110 have perspective based on the depth map. For example, the electronic device 101 may generate the second image 120 such that the lowland positioned within the portion of the second image 120 corresponding to the area 112 of the first image 110 has perspective based on the depth map. Operations in which the electronic device 101 generates the second image 120 based on the first image 110 and the depth map will be described in further detail herein, for example, with reference to FIGS. 5 to 6.

As described above, according to an embodiment, the electronic device 101 may infer information (e.g., a terrain (e.g., a ridge) of a mountain to be positioned in the area 114 filled with the second color, or perspective of the lowland to be positioned in the area 112 filled with the first color) not expressed by the first image 110. Based on the inferred information, the electronic device 101 may generate the realistic second image 120 from the first image 110. Hereinafter, one or more hardware included in the electronic device 101 of FIG. 1 to generate the second image 120 from the first image 110 will be described with reference to FIG. 2.

FIG. 2 is a block diagram of an electronic device 101, according to an embodiment. The electronic device 101 of FIG. 2 may be an example of the electronic device 101 of FIG. 1. Referring to FIG. 2, according to an embodiment, the electronic device 101 may include at least one of a processor 220, a memory 230, a display 240, or a communication circuit 250. The processor 220, the memory 230, the display 240, and the communication circuit 250 may be electronically and/or operably coupled with each other by an electronical component such as a communication bus 210. Although illustrated based on distinct blocks, the embodiment is not limited thereto, and a portion of a hardware component (e.g., at least a portion of the processor 220, the memory 230, and the communication circuit 250) illustrated in FIG. 2, may be included in a single integrated circuit, such as a system on a chip (SoC). A type and/or the number of the hardware component included in the electronic device 101 is not limited as illustrated in FIG. 2. For example, the electronic device 101 may include only a portion of the hardware component illustrated in FIG. 2.

According to an embodiment, the processor 220 of the electronic device 101 may include a hardware component for processing data based on one or more instructions. For example, the hardware component for processing data may include an arithmetic and logic unit (ALU), a floating point unit (FPU), a field programmable gate array (FPGA), a central processing unit (CPU), and/or an application processor (AP). The number of the processors 220 may be one or more. For example, the processor 220 may have a structure of a multi-core processor such as a dual core, a quad core, a hexa core, or octa core.

According to an embodiment, the memory 230 of the electronic device 101 may include a hardware component for storing data and/or instruction inputted and/or outputted to the processor 220. The memory 230 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multi-media card (eMMC).

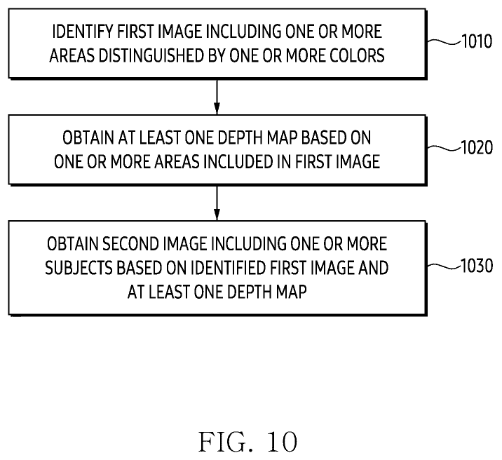

For example, in the memory 230, one or more instructions representing a calculation and/or an operation in which the processor 220 will perform to data may be stored. A set of the one or more instructions may be referred to as firmware, an operating system, a process, a routine, a sub-routine and/or an application. For example, the electronic device 101 and/or the processor 220 may perform at least one of operations of FIGS. 10 to 12, when a set of a plurality of instructions distributed in a form of an operating system, firmware, a driver, and/or an application is executed. Hereinafter, the application being installed in the electronic device 101 may mean that one or more instructions provided in the form of the application are stored in the memory 230 of the electronic device 101. The application being installed in the electronic device 101 may mean that the one or more applications are stored in an executable format (e.g., a file having an extension designated by the operating system of the electronic device 101) by the processor 220 of the electronic device 101.

According to an embodiment, the display 240 of the electronic device 101 may output visualized information (e.g., the first image 110 and/or the second image 120 of FIG. 1) to a user. For example, the display 240 may output the visualized information to the user, by being controlled by a controller such as a graphic processing unit (GPU). The display 240 may include a flat panel display (FPD) and/or an electronic paper. The FPD may include a liquid crystal display (LCD), a plasma display panel (PDP), and/or one or more light emitting diodes (LEDs). The LED may include an organic LED (OLED).

According to an embodiment, the communication circuit 250 of the electronic device 101 may include a hardware component for supporting transmission and/or receiving of an electrical signal between the electronic device 101 and an external electronic device. The communication circuit 250 may include, for example, at least one of a MODEM, an antenna, and an optic/electronic (O/E) converter. The communication circuit 280 may support the transmission and/or receiving of the electrical signal, based on various types of protocols such as ethernet, local area network (LAN), wide area network (WAN), wireless fidelity (WiFi), Bluetooth, Bluetooth low energy (BLE), a ZigBee, long term evolution (LTE), and 5G new radio (NR). By using the communication circuit 250, the electronic device 101 may receive the first image 110 of FIG. 1 from the external electronic device or transmit the second image 120 of FIG. 1 to the external electronic device.

As described above, according to an embodiment, the electronic device 101 may include one or more hardware for receiving, synthesizing, and/or displaying an image. The electronic device 101 may synthesize the image using software executed based on the one or more hardware. For synthesizing of the image, the electronic device 101 may execute software based on artificial intelligence such as a neural network. A conceptual structure of the software based on the artificial intelligence that may be executed by the electronic device 101 is described in detail herein, for example, with reference to FIGS. 6 to 8.

Hereinafter, an operation in which the electronic device 101 of FIG. 2 obtains a depth map from a semantic map such as the first image 110 of FIG. 1 will be described with reference to FIG. 3.

FIG. 3 is an exemplary diagram illustrating a depth map (e.g., depth maps 310, 320, and 330) that an electronic device generates from an image (e.g., a first image 110), according to an embodiment. The electronic device of FIG. 3 may be an example of the electronic device 101 of FIGS. 1 to 2. For example, the first image 110 of FIG. 3 may include the first image 110 of FIG. 1.

Referring to FIG. 3, according to an embodiment, an example of the first image 110 received from a user by the electronic device is illustrated. As described above with reference to FIG. 1, using one or more areas (e.g., areas 112, 114, 116, and 118) distinguished into distinct colors within the first image 110, the electronic device may identify one or more subjects to be included within another image (e.g., the second image 120 of FIG. 1) to be synthesized based on the first image 110. The electronic device may obtain one or more depth maps (e.g., the depth maps 310, 320, and 330) having distribution of distinct depth values in an area of the first image 110. The one or more depth maps may be used to provide perspective to the other image while the electronic device synthesizes the other image from the first image 110.

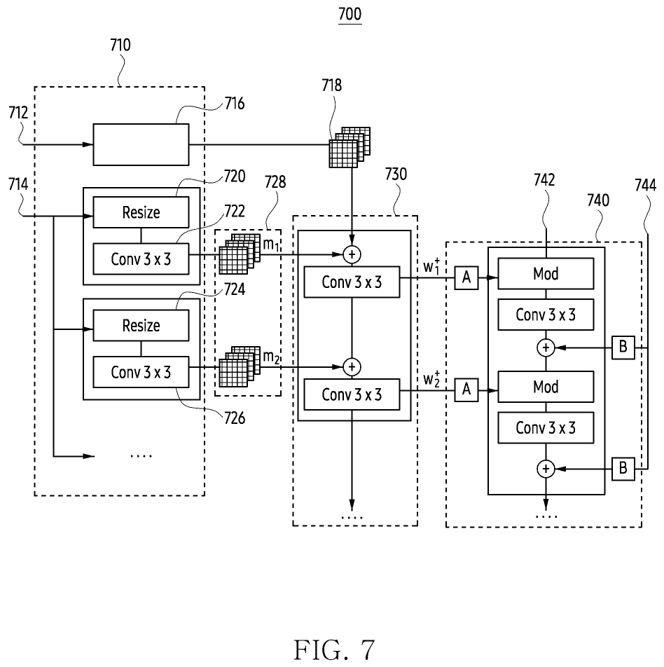

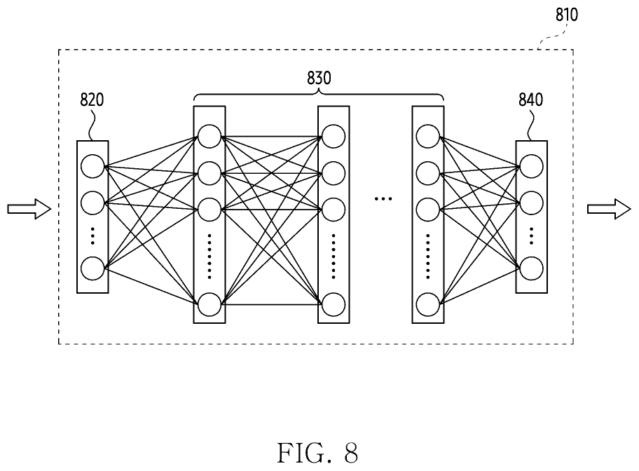

Referring to FIG. 3, according to an embodiment, the electronic device may obtain a plurality of depth maps 310, 320, and 330 selectable by a user from the first image 110. The electronic device may obtain the depth maps 310, 320, and 330 by assigning depth values to each of pixels of the first image 110 which is a semantic map. Although an embodiment, in which the electronic device obtains the three depth maps 310, 320, and 330 from the first image 110, is illustrated, the embodiment is not limited thereto. According to an embodiment, the number of depth maps that the electronic device obtains from the first image 110 may be 1 or more. According to an embodiment, an exemplary structure of a neural network in which an electronic device executes in order to obtain a depth map from the first image 110 is described in detail herein, for example, with reference to FIGS. 7 to 8. According to an embodiment, the electronic device may provide the user with selectable options based on the plurality of depth maps 310, 320, and 330 in order to identify the user's intention related to the first image 110.

For example, the electronic device may display at least one of the depth maps 310, 320, and 330 on a display (e.g., the display 240 of FIG. 2). The electronic device may display one or more visual objects (e.g., a radio button) for selecting a depth map among the depth maps 310, 320, and 330. The electronic device may select the depth map among the depth maps 310, 320, and 330 based on an input to the one or more visual objects. By using the selected depth map and the first image 110, the electronic device may synthesize a second image (e.g., the second image 120 of FIG. 1) using one or more neural network models. Within the above example, the electronic device may synthesize the second image reflecting the user's intention based on the depth map selected by the user.

For example, selectable options provided from the electronic device to the user and based on the plurality of depth maps 310, 320, and 330 may include an option to edit at least one of the plurality of depth maps 310, 320, and 330. The electronic device may display a UI and/or a screen capable of editing at least one of the depth maps 310, 320, and 330. The electronic device may display depth values assigned to pixels of at least one depth map in the UI based on distinct colors. According to an embodiment, the electronic device may change at least one depth map based on an input for adjusting the colors in the UI.

As described above, according to an embodiment, the electronic device may obtain at least one depth map (e.g., the depth maps 310, 320, and 330) based on one or more areas (e.g., the areas 112, 114, 116, and 118) included in the first image 110, based on the first image 110. The at least one depth map may represent perspective of the second image to be synthesized from the first image 110. In an embodiment in which the electronic device obtains the plurality of depth maps, the electronic device may provide the user with an option to select and/or change the plurality of depth maps.

Hereinafter, with reference to FIG. 4, distribution of depth values included in the depth map obtained by the electronic device from the first image 110 will be described.

FIG. 4 is an exemplary diagram illustrating distribution of a depth value in a depth map which an electronic device generates, according to an embodiment. The electronic device of FIG. 4 may be an example of the electronic device 101 of FIGS. 1 to 2. Depth maps 310 and 320 of FIG. 4 may correspond to the depth maps 310 and 320 of FIG. 3.

Referring to FIG. 4, according to an embodiment, graphs 410 and 420 for illustrating distribution of depth values in the depth maps 310 and 320, depth maps the electronic device obtains from the first image 110 of FIG. 1 are illustrated. The depth maps 310 and 320 may be obtained based on the operation of the electronic device described above with reference to FIG. 3. Referring to FIG. 4, the distribution of depth values of the depth maps 310 and 320 is illustrated based on density of dots. The density of dots may be inversely proportional to depth value, but the disclosure is not limited thereto. For example, as the density of dots increases, the depth values may decrease.

Referring to FIG. 4, a point A and a point B having a coordinate matched in the depth maps 310 and 320 are illustrated. Each of the graphs 410 and 420 may represent distribution of depth values assigned to pixels included on a line connecting the points A and B of the depth maps 310 and 320. An X-axis of the graphs 410 and 420 may represent a distance from the point A. A Y-axis of the graphs 410 and 420 may relatively represent a size of depth value. For example, the size of depth value may represent a distance between a subject within a second image (e.g., the second image 120 of FIG. 1) to be synthesized from the first image 110 and a virtual position where the second image is captured.

Referring to FIG. 4, the line connecting the point A and the point B (hereinafter, line A-B) may be included in an area 114 of the first image 110. For example, pixels within the first image 110 corresponding to the line may be a second color (e.g., brown). According to an embodiment, the electronic device may adjust depth values included in each of the depth maps 310 and 320, based on a type of subjects of each of areas 112, 114, 116, and 118, indicated by colors assigned to each of the areas 112, 114, 116, and 118 of the first image 110. For example, the electronic device may adjust distribution of depth values to express a terrain and/or a ridge of a mountain, in a portion of the depth maps 310 and 320 corresponding to the area 114 of the first image 110 filled with the second color representing the mountain.

Referring to an example of FIG. 4, according to an embodiment, the electronic device may express the ridge of the mountain by adjusting depth values between the A-B line of the depth map 310 included in the area 114 of the first image 110. For example, at a point C and a point D in the A-B line of the depth map 310, respectively, the electronic device may represent the ridge of the mountain based on a discontinuity of depth values. The electronic device may represent a single mountain by assigning depth values between the points A to C of the depth map 310 as continuous values. The electronic device may assign depth values between the points D to B of the depth map 310 to be smaller than the depth values between the points A to D.

Referring to FIG. 4, according to an embodiment, the electronic device may provide, by using the depth map 320 different from the depth map 310, perspective of the first image 110 differently from perspective based on the depth map 310. For example, referring to the graph 420, distribution of depth values between a A-B line of the depth map 320 may differ from the distribution of depth values between the A-B line of the depth map 310 illustrated by the graph 410. In the example, depth values between points A to E of the depth map 320 may be assigned to be smaller than depth values between points E to B. In case the electronic device synthesizes the second image based on the depth map 320 and the first image 110, a mountain including the points A to E may be displayed closer to another mountain including points F to B in the second image.

As described above, according to an embodiment, the electronic device may obtain one or more depth maps (e.g., the depth maps 310, 320, and 330 of FIG. 3) from a semantic map (e.g., the first image 110). The one or more depth maps may have different distribution of depth values. In an embodiment in which the electronic device obtains a plurality of depth maps from a semantic map, the electronic device may provide the plurality of depth maps to the user as a candidate depth map for synthesizing an image. Based on the depth map, the electronic device may synthesize an image having an improved perspective than that of the synthesized image by using the semantic map among the semantic map and the depth map. The electronic device may synthesize an image having a subject that matches the user's intention more than the image synthesized using the depth map among the semantic map and the depth map, by using the semantic map and the depth map simultaneously. Since distinct segments of the depth map are mapped one-to-one to distinct segments of an image (e.g., an output image) synthesized by the electronic device, the electronic device may support the user's intuitive editing of depth map and synthesizing the image based on the edited depth map.

Hereinafter, with reference to FIG. 5, an operation in which an electronic device according to an embodiment synthesizes one or more images, such as the second image 120 of FIG. 1, from the first image 110 will be described.

FIG. 5 is an exemplary diagram for illustrating an operation in which an electronic device generates one or more images based on an image received from a user and a depth map generated from the image, according to an embodiment. The electronic device of FIG. 5 may be an example of the electronic device 101 of FIGS. 1 to 2. A depth map 310 of FIG. 5 may correspond to the depth map 310 of FIGS. 3 to 4. A first image 110 of FIG. 5 may correspond to the first image 110 of FIGS. 1 and/or 3 to 4.

According to an embodiment, the electronic device may obtain one or more output images from the first image 110, which is an input image, and a single depth map (e.g., the depth map 310 of FIGS. 3 to 6) corresponding to the first image 110. Hereinafter, an operation in which the electronic device obtains one or more output images from the user in response to an input of selecting the depth map 310 from among a plurality of depth maps (e.g., the depth maps 310, 320, and 330 of FIG. 3) corresponding to the first image 110 is described. However, the embodiment is not limited thereto. For example, the electronic device may obtain one or more output images corresponding to each of the plurality of depth maps based on the plurality of depth maps received from the user.

FIG. 5 illustrates a first output image 510 and a second output image 520 as an example of the one or more output images obtained by the electronic device according to an embodiment from the depth map 310. According to an embodiment, the electronic device may display one or more subjects represented by the first image 110 based on perspective based on the depth map 310 within the one or more output images. In an embodiment in which the electronic device synthesizes the first output image 510 and the second output image 520, the lowland may be positioned in each portion of the first output image 510 and the second output image 520 corresponding to an area 112 of the first image 110. One or more mountains may be positioned in each portion of the first output image 510 and the second output image 520 corresponding to an area 114 of the first image 110. The sky may be positioned in each portion of the first output image 510 and the second output image 520 corresponding to an area 116 of the first image 110, and a cloud may be positioned in each portion of the first output image 510 and the second output image 520 corresponding to an area 118 of the first image 110.

Referring to FIG. 5, according to an embodiment, the electronic device may generate the first output image 510 and the second output image 520 based on distinct styles. A style may be adjusted differently according to the output image, according to a different combination of subjects included in a type indicated by the first image 110. For example, the style may be distinguished based on a mood and/or a style of painting of the output image. Referring to FIG. 5, each of a portion of the first output image 510 and a portion of the second output image 520, corresponding to the area 116 of the first image 110 may include different subjects (e.g., day sky, and night sky) within a type, such as sky. Referring to FIG. 5, each of a portion of the first output image 510 and a portion of the second output image 520 corresponding to the area 112 of the first image 110 may include distinct subjects within a type, such as the lowland. For example, the portion of the first output image 510 corresponding to the area 112 of the first image 110 may represent the lowland that does not include a lake. For example, the portion of the second output image 520 corresponding to the area 112 of the first image 110 may represent the other lowland, including a lake and a tree. For example, a portion of the first output image 510 corresponding to the area 114 of the first image 110 may include a plurality of mountains filled with trees. For example, a portion of the second output image 520 corresponding to the area 114 of the first image 110 may include snow-covered rocky mountains.

According to an embodiment, the electronic device may add perspective, based on the depth map 310, in distinct portions of the first output image 510 and the second output image 520, corresponding to each of the areas 112, 114, 116, and 118 of the first image 110, and/or at a boundary between the portions. Referring to FIG. 5, in a portion of the first output image 510 corresponding to the area 112 filled with a color representing the lowland of the first image 110, subjects (e.g., grass) representing the lowland may be displayed according to different size, different shape, and/or different color according to depth values of the portion corresponding to the area 112 of the first image 110 in the depth map 310. Referring to FIG. 5, in a portion of the first output image 510 corresponding to the area 114 filled with a color representing one or more mountains of the first image 110, a plurality of mountains may have one or more ridges based on depth values of a portion corresponding to the area 114 of the first image 110 in the depth map 310. According to an embodiment, in the portion of the first output image 510 and the portion of the second output image 520, corresponding to the area 114 of the first image 110, the electronic device may display a plurality of mountains based on the ridges indicated by the depth values of the depth map 310.

According to an embodiment, the electronic device may display the first output image 510 and the second output image 520 to the user. For example, the electronic device may display at least one of the first output image 510 or the second output image 520, which is a result of synthesizing an output image from the first image 110, which is a semantic map, in a display (e.g., the display 240 of FIG. 2). For example, the electronic device may transmit at least one of the first output image 510 or the second output image 520 to an external electronic device using a communication circuit (e.g., the communication circuit 250 of FIG. 2). At least one of the first output image 510 and the second output image 520 may be stored in memory (e.g., the memory 230 of FIG. 2) of the electronic device based on a format for representing an image, such as a joint photographic experts group (JPEG).

According to an embodiment, the electronic device may display at least one of the first output image 510 and the second output image 520 based on the depth map 310 in three dimensions. The electronic device may display an image (e.g., one of the first output image 510 or the second output image 520) having binocular disparity to each of the user's eyes, such as a head-mounted device (HMD). The binocular disparity may be provided to the user based on the depth map 310 in an embodiment in which the electronic device displays one of the first output image 510 or the second output image 520. For example, the depth map 310 obtained from the first image 110, which is a semantic map, may be stored in the electronic device together with at least one of the first output image 510 and the second output image 520.

As described above, according to an embodiment, the electronic device may include one or more subjects indicated by a color of each of the areas 112, 114, 116, and 118 from the first image 110 received from a user which has the areas 112, 114, 116, and 118 having a solid color, and may obtain one or more output images (e.g., the first output image 510 and the second output image 520) having perspective indicated by at least one depth map (e.g., the depth map 310) obtained from the first image 110. In case that the electronic device synthesizes another image (e.g., an image 530) from the first image 110 independently of the depth map 310, adding perspective to one or more subjects positioned in each of the areas 112, 114, 116, and 118 of the first image 110 may be limited. For example, while grass in a portion of the first output image 510 corresponding to the area 112 of the first image 110 may have distinct sizes based on the depth map 310, grass in a portion of the image 530 corresponding to the area 112 may have a matching size. According to an embodiment, the electronic device may additionally obtain at least one depth map corresponding to an input image (e.g., the first image 110) received from the user, and obtain one or more output images having perspective based on the obtained at least one depth map. The electronic device may support synthesis of a more realistic image (e.g., a landscape image) based on the one or more output images with perspective.

Hereinafter, referring to FIG. 6, according to an embodiment, a neural network used by an electronic device to synthesize an output image (e.g., the first output image 510 and/or the second output image 520) from an input image such as the first image 110, and a model based on the neural network will be described.

FIG. 6 is a diagram for illustrating a plurality of neural networks, which are stored in an electronic device, for generate an image, according to an embodiment. The electronic device of FIG. 6 may be an example of the electronic device 101 of FIGS. 1 to 2. A first image 110 of FIG. 6 may correspond to the first image 110 of FIGS. 1 and/or 3 to 5. Depth maps 310, 320, and 330 of FIG. 6 may correspond to each of the depth maps 310, 320, and 330 of FIG. 3. A first output image 510 and a second output image 520 of FIG. 6 may correspond to each of the first output image 510 and the second output image 520 of FIG. 5.

FIG. 6 is a diagram for describing one or more processes, which is executed in the electronic device according to an embodiment, for obtaining an output image (e.g., the first output image 510 and/or the second output image 520) from an input image (e.g., the first image 110). Referring to FIG. 6, a function and/or a sub-routine included in the one or more processes executed in the electronic device according to an embodiment is divided and illustrated according to information transmitted between the function and/or the sub-routine. According to an embodiment, the electronic device may execute one or more processes divided into blocks in FIG. 6 based on one or more instructions stored in memory (e.g., the memory 230 of FIG. 2). In an embodiment, for example, the processes may be executed in a second state, which is distinct from a first state shown to a user, such as a background process and/or a daemon.

Referring to FIG. 6, according to an embodiment, the electronic device may obtain one or more depth maps (e.g., the depth maps 310, 320, and 330) from the first image 110 based on the execution of a depth map generator 610. The depth map generator 610 may be a process (or a pipeline) of the electronic device to execute a neural network for generating one or more depth maps, based on an input image (e.g., the first image 110) including a plurality of areas distinguished by one or more colors, and a set (Z1) of one or more random numbers. The one or more random numbers may be selected independently of a rule of a sequence. The one or more random numbers may include a pseudo-random number randomly selected based on a timestamp expressed in a millisecond. The random numbers included in the set Z1 may be inputted to the depth map generator 610 together with the first image 110 to increase a diversity of the depth maps obtained by the depth map generator 610, while the electronic device executes the depth map generator 610. For example, the number of random numbers included in the set Z1 may match the number (e.g., three, which is the number of the depth maps 310, 320, and 330) of depth maps obtained by the electronic device using the depth map generator 610. The depth map generator 610 may be referred to as a semantic-to-depth translation unit.

Referring to FIG. 6, according to an embodiment, the electronic device may obtain one or more output images (e.g., the first output image 510 and the second output image 520) from the first image 110 and at least one depth map based on execution of an output image generator 620. The output image generator 620 may be a process (or a pipeline) of the electronic device for executing a neural network for synthesizing one or more output images, based on a depth map of the depth maps obtained by the depth map generator 610, the first image 110 inputted to the depth map generator 610, and a set Z2 of one or more random numbers. The random numbers included in the set Z2 may be inputted to the output image generator 620 together with the first image 110 and at least one depth map to adjust a diversity and/or a style of the output images synthesized by the output image generator 620 while the electronic device executes the output image generator 620. For example, the number of random numbers included in the set Z2 may match the number (e.g., two, which is the number of first output images 510 and second output images 520) of output images obtained by the electronic device using the output image generator 620. The output image generator 620 may be referred to as a semantic and depth-to-image translation unit.

As described above, according to an embodiment, the electronic device may obtain one or more output images (e.g., the first output image 510 and the second output image 520) from an input image such as the first image 110 based on a series connection between the depth map generator 610 and the output image generator 620. The series connection may be referred to as a 2-phase inference pipeline. The electronic device may provide an option of depth maps to the user while synthesizing an output image based on the series connection by using the depth map generator 610. The user may adjust perspective to be added to the output image to be obtained from the input image by selecting and/or editing any one of the depth maps. Since the electronic device synthesizes the output image based on a specific depth map selected and/or edited by the user, the electronic device may synthesize the output image matching the user's intention.

Hereinafter, a structure common to the depth map generator 610 and the output image generator 620 of FIG. 6 will be described with reference to FIG. 7.

FIG. 7 is a block diagram for illustrating a structure of a model 700, which is stored in an electronic device, and to generate an image, according to an embodiment. The electronic device of FIG. 7 may be an example of the electronic device 101 of FIGS. 1 to 2. A model 700 of FIG. 7 is an exemplary block diagram for illustrating a software implemented algorithm which is included in the depth map generator 610 and the output image generator 620 of FIG. 6. Model 700 may be included in one or both of the in the depth map generator 610 and the output image generator 620.

Referring to FIG. 7, according to an embodiment, the model 700 that the electronic device uses from an input image (e.g., the first image 110 of FIG. 1) to generate one or more output images (e.g., the second image 120 of FIG. 1) may have a structure at least based on a styleGAN model. In an embodiment, based on the styleGAN model, the model 700 may have a structure changed to generate one or more depth maps. In an embodiment, based on the styleGAN model, the model 700 may have a structure changed to generate the output image from a semantic map (e.g., the input image) and/or a depth map.

Referring to FIG. 7, the model 700 may include a condition preparation module 710 receiving at least one image 714 and one or more random numbers 712, a condition fusion module 730 receiving information (e.g., feature map, feature information, feature vector, and/or latent map) generated based on the condition preparation module 710, and an image synthesis module 740 receiving the information obtained from the condition fusion module 730 and random numbers 744 such as noise. Since the model 700 includes the condition preparation module 710, the electronic device may change a diversity of at least one image outputted by the image synthesis module 740 based on the random numbers 712. For example, the random numbers 712 may be elements of the sets Z1 and Z2 of the random numbers of FIG. 6.

According to an embodiment, the electronic device may obtain latent maps 718 based on the random numbers 712, based on a mapping network 716 of the condition preparation module 710 of the model 700. The latent maps 718 may be referred to as a random latent map. The latent maps 718 may include a plurality of numeric values outputted from the mapping network 716 while the random numbers 712 propagate along a plurality of layers in the mapping network 716. The latent maps 718 may be 3D information on the number of a channel, a width, and a height of the mapping network 716. The width and/or the breadth may be a width and/or a breadth of an output image to be synthesized based on the model 700. The number of the channel may have different numeric values according to an implementation of the model 700. The number of latent maps 718 may match the number of random numbers 712 received by the condition preparation module 710.

According to an embodiment, the electronic device may perform a resize (e.g., a size represented by blocks 720 and 724, and defined differently for each block 720 and 724), and perform convolution (e.g., a convolution operation represented by blocks 722 and 726) of at least one image 714 based on the condition preparation module 710 of the model 700. Referring to FIG. 7, a convolution operation may be performed after at least one image 714 is adjusted to a first size, based on a connection of the blocks 720 and 722. Referring to FIG. 7, a convolution operation may be performed after at least one image 714 is adjusted to a second size different from the first size, based on a connection of the blocks 722 and 726. According to an embodiment, the electronic device may obtain a plurality of conditional latent codes 728 based on a convolution operation (e.g., the convolution operation represented by the blocks 722 and 726) corresponding to different sizes in the model 700.

According to an embodiment, the plurality of conditional latent codes 728, which the electronic device obtains from the condition preparation module 710, may include information in which a result (e.g., a condition map) of the convolution operation is combined channel-wise. The conditional latent codes 728 may be 3D information based on the number of a channel, a width, and a breadth, similar to the latent maps 718. The number of channels, the width, and the breadth of the conditional latent codes 728 may be independently set for each conditional latent code 728. In an embodiment, the width and the breadth of the condition latent codes 728 may match the width and the breadth of the output image to be synthesized by the model 700.

According to an embodiment, the electronic device may perform synthesis on the latent maps 718 obtained based on the random numbers 712 and the conditional latent codes 728, by using the condition fusion module 730 in the model 700. The synthesis may be performed to match a feature in the image synthesis module 740 based on a convolution operation and an up-sampling operation. Referring to FIG. 7, w₁⁺ and w₂⁺ may be referred to as an intermediate fusion map. The intermediate fusion map may include a result in which the electronic device performs the synthesis based on the condition fusion module 730. According to an embodiment, the electronic device may input an i-th intermediate fusion map w₁⁺ as a specific layer (e.g., an i+1-th layer) of the condition fusion module 730, which is distinguished by a convolution operation. The random numbers 744 such as noise may be inputted to each layer of the image synthesis module 740. A serial convolution operation in the image synthesis module 740 may be performed sequentially until a size of at least one image 714 inputted to the model 700 is reached.

According to an embodiment, the electronic device may obtain an affine transform of an intermediate fusion map (e.g., the intermediate fusion map w₁⁺ of the i-th layer) of each layer of the condition fusion module 730 by using the image synthesis module 740 in the model 700. The electronic device may input a designated numeric value 742 (e.g., a constant number) to the image synthesis module 740. The designated numeric value 742 may be set for image synthesis in the styleGAN model. The electronic device may add noise per pixel using the random numbers 744. The random numbers 744 may be inputted to the model 700 to increase the diversity of images synthesized by the model 700. According to an embodiment, the electronic device may train the model 700 based on adversarial learning.

Each of the depth map generator 610 and the output image generator 620 of FIG. 6 may include the model 700 of FIG. 7. For example, the depth map generator 610 of FIG. 6 may receive one or more random numbers (e.g., elements of the set Z1 of random numbers of FIG. 6) and a semantic map (e.g., the first image 110 of FIG. 1) through the condition preparation module 710 of FIG. 7. For example, while executing the depth map generator 610 of FIG. 6, the electronic device may obtain one or more depth maps corresponding to the one or more random numbers from the semantic map based on the operation described above with reference to FIG. 7. For example, the electronic device may obtain a plurality of depth maps based on the affine transform of the image synthesis module 740.

For example, the output image generator 620 of FIG. 6 may obtain a depth map and a semantic map selected by a user, using the condition preparation module 710 for receiving at least one image 714 of FIG. 7. By using the depth map, the semantic map, and one or more random numbers (e.g., elements of the set Z2 of random numbers of FIG. 6), the electronic device may synthesize one or more output images. The electronic device synthesizing the output images may be performed based on the image synthesis module 740 included in the output image generator 620 of FIG. 6.

As described above, the electronic device according to an embodiment may obtain a high-quality output image (e.g., an output image having a size of 1024×1024) using a neural network based on a convolution operation. Hereinafter, a neural network based on a convolution operation, such as the blocks 722 and 726, according to an embodiment, will be described with reference to FIG. 8.

FIG. 8 is a diagram for illustrating a neural network 810 stored in an electronic device, according to an embodiment. The electronic device of FIG. 8 may include the electronic device 101 of FIGS. 1 to 2. FIG. 8 is an exemplary diagram for explaining a neural network 810 obtained by the electronic device according to an embodiment from a set of parameters stored in memory. The neural network 810 of FIG. 8 may be included in the model 700 of FIG. 7. For example, the model 700 of FIG. 7 may include a neural network represented based on a set of a plurality of parameters stored in the memory (e.g., the memory 120 of FIGS. 1 to 2). Referring to FIG. 8, neurons of the neural network for performing the convolution operation of the model 700 of FIG. 7 may be distinguished along a plurality of layers. The neurons may be represented by a connection line connecting a specific node included in a specific layer and another node included in another layer different from the specific layer, and/or a weight assigned to the connection line. For example, the neural network 810 may include an input layer 820, hidden layers 830, and an output layer 840. The number of hidden layers 830 may be different according to an embodiment.

Referring to FIG. 8, the input layer 820 may receive a vector (e.g., a vector having elements corresponding to the number of nodes included in the input layer 820) representing input data. Based on the input data, signals generated from each of the nodes in the input layer 820 may be transmitted from the input layer 820 to the hidden layers 830. The output layer 840 may generate output data of the neural network 810 based on one or more signals received from one hidden layer (e.g., the last hidden layer in a sequence of the hidden layers 830) of the hidden layers 830. The output data may include, for example, a vector having elements mapped to each of nodes included in the output layer 840.

Referring to FIG. 8, the hidden layers 830 may be positioned between the input layer 820 and the output layer 840. Numeric values received through the nodes of the input layer 820 may be changed based on a weight assigned between the hidden layers 830 while propagating along the chain connection of the hidden layers 830. For example, as the input data received through the input layer 820 propagates sequentially along the hidden layers 830 from the input layer 820, the input data may be gradually changed based on a weight connecting the nodes of different layers.

As described above, each of the layers (e.g., the input layer 820, the hidden layers 830, and the output layer 840) of the neural network 810 may include a plurality of nodes. The connection between the hidden layers 830 may be related to a convolution filter in a convolutional neural network (CNN).

A structure in which nodes are connected between different layers is not limited to an example of FIG. 8. In an embodiment, one or more hidden layers 830 may be layers based on a recurrent neural network (RNN) in which an output value is inputted back to the hidden layer of the current time. In an embodiment, at least one of the values of the nodes of the neural network 810 may be discarded, maintained for a relatively long period of time, or maintained for a relatively short period of time, based on a long short-term memory (LSTM). According to an embodiment, the neural network 810 of the electronic device may form a deep neural network by including a relatively increased number of hidden layers 830. Training a deep neural network is called deep learning. A node included in the hidden layers 830 may be referred to as a hidden node.

Nodes included in the input layer 820 and the hidden layers 830 may be connected to each other through a connection line (e.g., a convolution filter represented by a 2D matrix including the weight) having a weight, and nodes included in the hidden layer and the output layer may also be connected to each other through the connection line having a weight. Tuning and/or training the neural network 810 may mean changing weights between nodes included in each of the layers (e.g., the input layer 820, the hidden layers 830, and the output layer 840) of the neural network 810. The Tuning of the neural network 810 may be performed, for example, based on supervised learning and/or unsupervised learning.

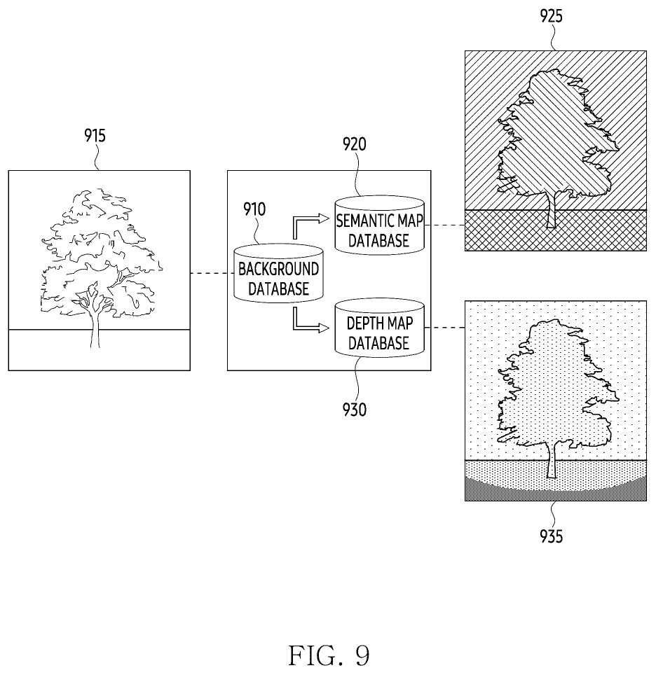

Hereinafter, an operation in which an electronic device according to an embodiment tunes a model (e.g., the model 700 of FIG. 7) including the neural network 810 will be described with reference to FIG. 9.

FIG. 9 is a diagram for illustrating an operation of generating a data set, which is stored in an electronic device, to generate an image and train a model, according to an embodiment. The electronic device of FIG. 9 may be an example of the electronic device 101 of FIGS. 1 to 2. The model of FIG. 9 may include the model 700 of FIG. 7.

Referring to FIG. 9, the electronic device according to an embodiment may obtain a depth map 935 representing distribution of depth values of an image 915, and a semantic map 925 for representing a position, a size, and/or a shape of one or more subjects in the image 915 from the image 915. The image 915 may include a photograph such as a landscape photograph. The image 915 may be stored in a background database 910. The depth map 935 may be stored in a depth map database 930. The semantic map 925 may be stored in a semantic map database 920. For example, the electronic device may train a model (e.g., the model 700 of FIG. 7) for synthesizing an output image from a semantic map, based on a combination of a plurality of images (e.g., the image 915) stored in the background database 910, a plurality of semantic maps (e.g., the semantic map 925) stored in the semantic map database 920, and a plurality of depth maps (e.g., the depth map 935) stored in the depth map database 930.

For example, the depth map generator 610 of FIG. 6, which has a structure of the model 700 of FIG. 7, may be trained based on a pair of the plurality of semantic maps stored in the semantic map database 920 and the plurality of depth maps stored in the depth map database 930. For example, the output image generator 620 of FIG. 6, which has a structure of the model 700 of FIG. 7, may be trained based on a combination of an image (e.g., the image 915), a semantic map (e.g., the semantic maps 925), and a depth map (e.g., the depth map 935) stored in each of the background database 910, the semantic map database 920, and the depth map 930.

According to an embodiment, the electronic device may train the model based on adversarial learning. For example, the electronic device may measure a similarity between the image synthesized by the model and the image stored in the background database 910, based on a model different from the model. Based on the measured similarity, the electronic device may train the model. The electronic device may perform adversarial learning based on the model and the different model, based on at least one of an adversarial loss, a perceptual loss, a domain-guided loss, a reconstruction loss, or regularization.

As described above, according to an embodiment, the electronic device may synthesize an output image from another semantic map (e.g., a semantic map not stored in the semantic map database 920) different from the semantic map 925, based on the neural network trained by the depth map 935 and the semantic map 925 inferred from the image 915 such as a photo. The synthesized output image may have a resolution similar to that of the image 915 stored in the background database 910. The synthesized output image may have image quality and/or depth accuracy similar to that of the image 915.

FIG. 10 is a diagram for illustrating an operation of an electronic device, according to an embodiment. The electronic device of FIG. 10 may include the electronic device 101 of FIGS. 1 to 2. At least one of operations of FIG. 10 may be performed by the electronic device 101 of FIGS. 1 to 2 and/or the processor 220 of FIG. 2.

Referring to FIG. 10, in operation 1010, the electronic device according to an embodiment may identify a first image (e.g., the first image 110 of FIG. 1) including one or more areas distinguished by one or more colors. The first image may be a semantic map for representing one or more subjects based on at least one of a shape of the one or more areas, or one or more colors filled in the one or more areas. For example, the semantic map may include a plurality of areas filled with distinct colors. In the example, the distinct colors may represent a type of the one or more subjects. In the example, the shape of the plurality of areas may represent the shape and the position of the one or more subjects.

Referring to FIG. 10, in operation 1020, the electronic device according to an embodiment may obtain at least one depth map based on the one or more areas included in the first image. For example, the electronic device may obtain the at least one depth map based on the depth map generator 610 of FIG. 6. The depth map generator 610 of FIG. 6 may have a structure of the model 700 of FIG. 7. In an embodiment, the electronic device may obtain a plurality of candidate depth maps. The plurality of candidate depth maps may have different distribution of depth values based on a plurality of random numbers. The at least one depth map obtained by the electronic device may have different depth values in an area of the first image of the operation 1010. For example, a depth value assigned to a first pixel in a specific area filled with a solid color of the first image and a depth value assigned to a second pixel in the specific area may be different from each other.

According to an embodiment, the electronic device may receive an input for selecting any one of the plurality of candidate depth maps or editing at least one of the plurality of candidate depth maps. In response to the input, the electronic device may determine a depth map. Based on the determined depth map, the electronic device may perform operation 1030.

Referring to FIG. 10, in the operation 1030, the electronic device according to an embodiment may obtain a second image including one or more subjects based on the identified first image and the at least one depth map. The at least one depth map may include the determined depth map. The second image may include an output image (e.g., the second image 120 of FIG. 1) synthesized from the first image of the operation 1010. For example, in case that the first image includes a plurality of areas distinguished by a plurality of colors, the electronic device may obtain the second image including a plurality of subjects having distinct types respectively matched to the plurality of colors.

According to an embodiment, the electronic device may obtain one or more second images based on one or more random numbers, the first image, and the at least one depth map. For example, the electronic device may obtain the one or more second images based on the output image generator 620 of FIG. 6. The output image generator 620 of FIG. 6 may have a structure of the model 700 of FIG. 7. The electronic device may display the one or more second images on a display (e.g., the display 240 of FIG. 2). The electronic device may store the one or more second images in memory 230. The electronic device may store the one or more second images together with the identified depth map in operation 1130.

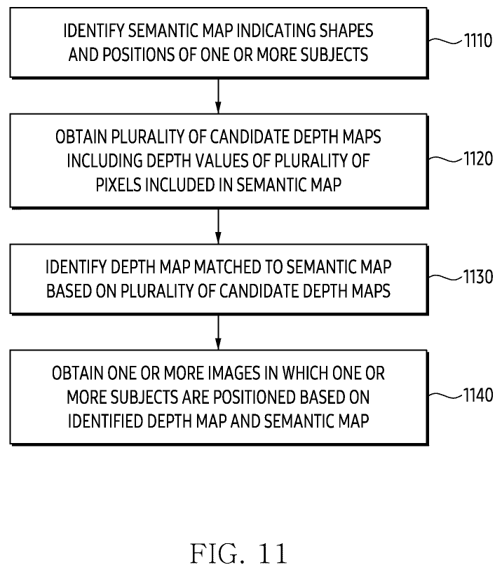

FIG. 11 is a diagram for illustrating an operation of an electronic device, according to an embodiment. The electronic device of FIG. 11 may include the electronic device 101 of FIGS. 1 to 2. At least one of the operations of FIG. 11 may be performed by the electronic device 101 of FIGS. 1 to 2 and/or the processor 220 of FIG. 2.

Referring to FIG. 11, in operation 1110, the electronic device according to an embodiment may identify a semantic map indicating shapes and positions of one or more subjects. The semantic map may include the first image 110 of FIG. 1. Similar to the operation 1010 of FIG. 10, the electronic device may perform the operation 1110 of FIG. 11. Colors of pixels in the semantic map may represent types of the one or more subjects, and shapes and positions of areas distinguished by the colors may represent the shapes and the positions of the one or more subjects.

Referring to FIG. 11, in operation 1120, the electronic device according to an embodiment may obtain a plurality of candidate depth maps including depth values of a plurality of pixels included in the semantic map. The electronic device may obtain the plurality of candidate depth maps from the semantic map of the operation 1110 using a first neural network. The first neural network may have a structure of the neural network 810 of FIG. 8. The first neural network may be included in the model 700 of FIG. 7. The first neural network may be included in at least a portion of the depth map generator 610 of FIG. 6.

Referring to FIG. 11, in operation 1130, the electronic device according to an embodiment may identify a depth map matched to the semantic map based on the plurality of candidate depth maps. For example, the electronic device may provide a user with options corresponding to each of the plurality of candidate depth maps. The electronic device may receive an input for selecting any one of the options from the user. In response to the input, the electronic device may identify a depth map matched to the semantic map of the operation 1110. For example, the electronic device may provide the user with a screen for editing at least one of the plurality of candidate depth maps. The electronic device may determine a depth map edited by the user as a depth map matched to the semantic map of the operation 1110.

Referring to FIG. 11, in operation 1140, the electronic device according to an embodiment may obtain one or more images in which the one or more subjects are positioned based on the identified depth map and the semantic map. The electronic device may obtain the one or more images of the operation 1140 using a second neural network. The second neural network may have a structure of the neural network 810 of FIG. 8. The second neural network may be included in the model 700 of FIG. 7. The second neural network may be included in at least a portion of the output image generator 620 of FIG. 6.

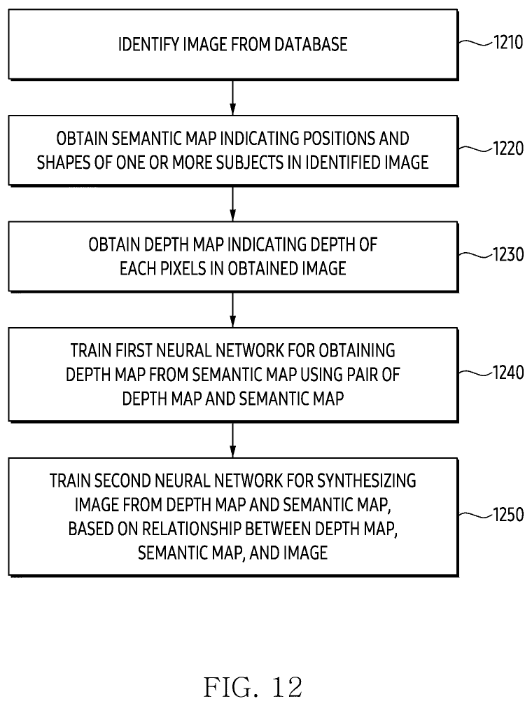

FIG. 12 is a diagram for illustrating an operation of training a neural network of an electronic device, according to an embodiment. The electronic device of FIG. 12 may include the electronic device 101 of FIGS. 1 to 2. At least one of operations of FIG. 12 may be performed by the electronic device 101 of FIGS. 1 to 2 and/or the processor 220 of FIG. 2.

Referring to FIG. 12, in operation 1210, the electronic device according to an embodiment may identify an image from a database. The database of the operation 1210 may include the background database 910 of FIG. 9. The image of the operation 1210 may include the image 915 of FIG. 9. For example, the electronic device may identify a plurality of photographs, such as a landscape photograph, from the database.

Referring to FIG. 12, in operation 1220, the electronic device according to an embodiment may obtain a semantic map representing positions and shapes of one or more subjects in the identified image. For example, the electronic device may identify a type of a subject captured in each of pixels of the image of the operation 1210 based on a neural network. The electronic device may obtain the semantic map by replacing the pixels of the image of the operation 1210 with a color corresponding to the identified type. For example, the type of the subject captured in each pixel of the image may be indicated by color in the semantic map. The semantic map of the operation 1220 may be stored as a pair of images of the operation 1210 in another database (e.g., the semantic map database 920 of FIG. 9) different from the database of the operation 1210.

Referring to FIG. 12, in operation 1230, the electronic device according to an embodiment may obtain a depth map representing a depth of each pixels in the obtained image. For example, the electronic device may identify a distance between the subject captured in each of the pixels of the image of the operation 1210 and a camera capturing the image, based on another neural network different from the neural network of the operation 1220. The electronic device may obtain the depth map by replacing the pixels of the image of the operation 1220 with a color for representing a numeric value of a single axis, such as a gray scale. The depth map of the operation 1230 may be stored as a pair of images of the operation 1210 and the semantic maps of the operation 1220 in another database (e.g., the depth map database 930 of FIG. 9) different from the databases of the operations 1210 and 1220.

The order of the operations 1220 and 1230 of FIG. 12 is not limited to the order in FIG. 12. For example, the operations 1220 and 1230 may be performed simultaneously by the electronic device, or may be performed in the order different from the order of the operations 1220 and 1230 of FIG. 12.

Referring to FIG. 12, in operation 1240, the electronic device according to an embodiment may train a first neural network for obtaining a depth map from the semantic map using a pair of the depth map and the semantic map. Referring to FIG. 12, in operation 1250, the electronic device according to an embodiment may train a second neural network for synthesizing an image from the depth map and the semantic map, based on a relationship between the depth map, the semantic map, and the image. The first neural network to the second neural network may have a structure of the neural network 810 of FIG. 8, and may be included as a portion of the model 700 of FIG. 7. The first neural network may be included in the depth map generator 610 of FIG. 6. The second neural network may be included in the output image generator 620 of FIG. 6. The order of the operations 1240 and 1250 of FIG. 12 is not limited to the order in FIG. 12. For example, the operations 1240 and 1250 may be performed simultaneously by the electronic device, or may be performed in the order different from the order of the operations 1240 and 1250 of FIG. 12.

As described above, the electronic device according to an embodiment may obtain one or more depth maps from the semantic map in order to synthesize a realistic image from the semantic map. The one or more depth maps may be used to add perspective to the image to be synthesized by the electronic device. The electronic device may receive an input related to the one or more depth maps based on a structure in which trained neural networks are connected in a chain. In response to the input, the electronic device may synthesize an image based on intention of the user who has performed the input.

As described above, according to an embodiment, an electronic device may comprise memory for storing instructions and at least one processor operably coupled to the memory. The at least one processor may be configured to, when the instructions are executed, identify a first image including one or more areas distinguished by one or more colors. The at least one processor may be configured to obtain, based on the identified first image, at least one depth map based on the one or more areas included in the first image. The at least one processor may be configured to obtain, based on the identified first image and the at least one depth map, a second image including one or more subjects indicated by colors of the one or more areas.

For example, the at least one depth map may include a first depth value that is assigned to a first pixel within a first area among the one or more areas. The at least one depth map may include a second depth value different from the first depth value that is assigned to a second pixel, which is different from the first pixel, within the first area.

For example, the at least one processor may be configured to, when the instructions are executed, obtain the first image including a plurality of areas distinguished by a plurality of colors. The at least one processor may be configured to obtain, based on the at least one depth map, the second image including a plurality of subjects having distinct types respectively matched to the plurality of colors.

For example, the at least one processor may be configured to, when the instructions are executed, obtain, based on the identified first image, a plurality of depth maps. The at least one processor may be configured to obtain, in response to an input indicating to select one depth map among the plurality of depth maps, the second image based on the selected depth map and the first image.

For example, the electronic device may further comprise a display. The at least one processor may be configured to, when the instructions are executed, display, in response to obtaining the at least one depth map, a screen to adjust at least one depth value included in the at least one depth map, in the display.

For example, the at least one processor may be configured to, when the instructions are executed, obtain, by inputting the first image, and at least one random number to a neural network indicated by a plurality of parameters stored in the memory, the at least one depth map.

For example, the at least one processor may be configured to, when the instructions are executed, obtain, by inputting the at least one depth map, the first image, and at least one random number to a neural network indicated by a plurality of parameters stored in the memory, the second image.

For example, the first image may be a semantic map to indicate the one or more subjects, based on at least one of a shape of the one or more areas, or the one or more colors which are filled in the one or more areas.

For example, the second image may include terrain indicated by the at least one depth map.

For example, the at least one processor may be configured to, when the instructions are executed, obtain, based on the first image, the at least one depth map indicating depth distribution within the one or more areas. The at least one processor may be configured to obtain the second image including the one or more subjects positioned based on the depth distribution.

As described above, according to an embodiment, a method of an electronic device may comprise identifying a semantic map indicating shapes, and locations of one or more subjects. The method of the electronic device may comprise obtaining, based on the semantic map, a plurality of candidate depth maps including depth values of a plurality of pixels included in the semantic map. The method of the electronic device may comprise identifying, based on the plurality of candidate depth maps, a depth map matched to the semantic map. The method of the electronic device may comprise obtaining, one or more images in which the one or more subjects are positioned based on the identified depth map, and the semantic map.

For example, the semantic map may include a plurality of areas in which distinct colors are filled. The distinct colors may indicate types of the one or more subjects, and shapes of the plurality of areas may indicate the shapes of the one or more subjects, and the positions.

For example, the obtaining the plurality of candidate depth maps may comprise obtaining, using a neural network receiving the semantic map, and at least one numeric value, the plurality of candidate depth maps including depth distribution within a first area among the plurality of areas.

For example, the identifying the depth map may comprise displaying the plurality of candidate depth maps in a display of the electronic device. The identifying the depth map may comprise receiving an input indicating to select one depth map among the plurality of candidate depth maps. The identifying the depth map may comprise identifying the selected depth map by the input, as a depth map matched to the semantic map.

The obtaining the one or more images may comprise obtaining, using a neural network receiving the identified depth map and one or more random numbers, the one or more images. The number of the one or more images may be matched to the number of the one or more random numbers.

As described above, a method of an electronic device may comprise identifying a first image including one or more areas distinguished by one or more colors. The method of the electronic device may comprise obtaining, based on the identified first image, at least one depth map based on the one or more areas included in the first image. The method of the electronic device may comprise obtaining, based on the identified first image and the at least one depth map, a second image including one or more subjects indicated by colors of the one or more areas.

For example, the at least one depth map may include a first depth value that is assigned to a first pixel within a first area among the one or more areas, and a second depth value different from the first depth value that is assigned to a second pixel, which is different from the first pixel, within the first area.

For example, the obtaining the second image may comprise obtaining, based on the first image including a plurality of areas distinguished by a plurality of colors, and the at least one depth map, the second image including a plurality of subjects having distinct types respectively matched to the plurality of colors.

For example, the obtaining the at least one depth map may comprise obtaining, based on the identified first image, a plurality of depth maps. For example, the obtaining the second image may comprise obtaining, in response to an input indicating to select one depth map among the plurality of depth maps, the second image based on the selected depth map, and the first image.

For example, the obtaining the at least one depth map may comprise displaying, in response to obtaining the at least one depth map, a screen to adjust at least one depth value included in the at least one depth map, in a display of the electronic device.

As described above, according to an embodiment, an electronic device may comprise memory for storing instructions and at least one processor operably coupled to the memory. The at least one processor may be configured to, when the instructions are executed, identify a semantic map indicating shapes, and locations of one or more subjects. The at least one processor may be configured to obtain, based on the semantic map, a plurality of candidate depth maps including depth values of a plurality of pixels included in the semantic map. The at least one processor may be configured to obtain, one or more images in which the one or more subjects are positioned based on the identified depth map, and the semantic map.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include may be those configured to store program instructions, including a magnetic medium such as a hard disk, floppy disk, and magnetic tape, optical recording medium such as a CD-ROM and DVD, magneto-optical medium, such as a floptical disk, and ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device comprising:
memory storing instructions; and
at least one processor operably coupled to the memory,
wherein the at least one processor is configured to:
identify a first image comprising one or more areas distinguished by one or more colors;
obtain at least one depth map based on the first image, wherein the at least one depth map comprises the one or more areas in the first image; and
obtain, based on the first image and the at least one depth map, a virtual image including one or more subjects indicated by colors of the one or more areas.

2. The electronic device of claim 1, wherein the at least one depth map comprises a first depth value that is assigned to a first pixel within a first area among the one or more areas, and a second depth value that is assigned to a second pixel within the first area, wherein the first depth value is different from the second depth value, and wherein the second pixel is different from the first pixel.

3. The electronic device of claim 1, wherein the first image comprises a plurality of areas distinguished by a plurality of colors, and wherein the at least one processor is further configured to:
obtain, based on the first image and the at least one depth map, the virtual image,
wherein the virtual image comprises a plurality of subjects having distinct types, with the plurality of subjects are respectively corresponding to the plurality of colors.

4. The electronic device of claim 1, wherein the at least one processor is further configured to:
obtain, based on the first image, the at least one depth map;
obtain, in response to an input indicating a selection of a first depth map among the at least one depth map, the virtual image based on the first depth map and the first image.

5. The electronic device of claim 1, further comprises,
a display,
wherein the at least one processor is further configured to:
display, in response to obtaining the at least one depth map, a screen to adjust at least one depth value included in the at least one depth map, on the display.

6. The electronic device of claim 1, wherein the at least one processor is further configured to:
obtain the at least one depth map by inputting the first image and at least one random number to a neural network indicated by a plurality of parameters stored in the memory.

7. The electronic device of claim 1, wherein the at least one processor is further configured to:
obtain the virtual image by inputting the at least one depth map, the first image, and at least one random number to a neural network indicated by a plurality of parameters stored in the memory.

8. The electronic device of claim 1, wherein the first image is a semantic map to indicate the one or more subjects, wherein the one or more subjects are indicated based on at least one of a shape of the one or more areas, or the one or more colors which are filled in the one or more areas.

9. The electronic device of claim 1, wherein the virtual image includes terrain indicated by the at least one depth map.

10. The electronic device of claim 1, wherein the at least one processor is further configured to:
obtain, based on the first image, the at least one depth map indicating depth distribution within the one or more areas,
obtain the virtual image including the one or more subjects positioned based on the depth distribution.

11. A method of generating a virtual image, the method being executed by at least one processor of an electronic device, the method comprising:
identifying a semantic map indicating shapes and locations of one or more subjects;
obtaining a plurality of candidate depth maps based on the semantic map, wherein the plurality of candidate depth maps comprise depth values of a plurality of pixels included in the semantic map;
identifying a depth map corresponding to the semantic map based on the plurality of candidate depth maps; and
obtaining, one or more images in which the one or more subjects are positioned based on the identified depth map, and the semantic map.

12. The method of claim 11, wherein the semantic map comprises:
a plurality of areas in which distinct colors are filled,
wherein the distinct colors indicate types of the one or more subjects, and shapes of the plurality of areas indicate the shapes of the one or more subjects.

13. The method of claim 12, wherein the obtaining the plurality of candidate depth maps comprises:
obtaining the plurality of candidate depth maps based on using a neural network receiving the semantic map and at least one numeric value, wherein the plurality of candidate depth maps comprise depth distribution within a first area among the plurality of areas.

14. The method of claim 11, wherein the identifying the depth map comprises:
displaying the plurality of candidate depth maps on a display of the electronic device;
receiving an input indicating selection of a first depth map among the plurality of candidate depth maps; and
identifying the first depth map by the input, as a depth map corresponding to the semantic map.

15. The method of claim 11, wherein the obtaining the one or more images comprises:
obtaining, using a neural network receiving the identified depth map and one or more random numbers, the one or more images,
wherein a number of the one or more images is matched to a number of the one or more random numbers.

16. A non-transitory computer readable medium storing instructions, wherein the instructions cause at least one processor to:
identifying a first image comprising one or more areas distinguished by one or more colors;
obtaining at least one depth map based on the first image, wherein the at least one depth map comprises the one or more areas included in the first image; and
obtaining, based on the first image and the at least one depth map, a virtual image including one or more subjects indicated by colors of the one or more areas.

17. The non-transitory computer readable medium of claim 16, wherein the at least one depth map includes,
a first depth value that is assigned to a first pixel within a first area among the one or more areas, and a second depth value that is assigned to a second pixel within the first area, wherein the first depth value is different from the second depth value, and wherein the second pixel is different from the first pixel.

18. The non-transitory computer readable medium of claim 16, wherein the first image comprises a plurality of areas distinguished by a plurality of colors, and wherein the obtaining the virtual image comprises:
obtaining, based on the first image and the at least one depth map, wherein the virtual image comprises a plurality of subjects having distinct types, with the plurality of subjects are respectively corresponding to the plurality of colors.

19. The non-transitory computer readable medium of claim 16, wherein the obtaining the at least one depth map comprises:
obtaining, based on the first image, the at least one depth map,
wherein the obtaining the virtual image comprises:
obtaining, in response to an input indicating a selection of a first depth map among the at least one depth maps, the virtual image based on the first depth map, and the first image.

20. The non-transitory computer readable medium of claim 16, wherein the obtaining the at least one depth map comprises:
displaying, in response to obtaining the at least one depth map, a screen to adjust at least one depth value included in the at least one depth map, on a display of the electronic device.
